(19) United States
(12) Patent Application Publication
(10) Pub. No.: US 2021/0027650 A1
(43) Pub. Date: Jan. 28, 2021

(54) A PLATFORM ALLOWING ALCOHOL COMPANIES TO CONVENIENTLY REACH, TRAIN AND INFLUENCE PEOPLE SELLING THEIR PRODUCTS ACROSS SERVICE INDUSTRIES

(71) Applicant: SMALL BATCH LEARNING PTE. LTD., SINGAPORE (SG)

(72) Inventor: Adam Jonathan Leibrandt, Singapore (SG)

(21) Appl. No.: 17/045,353

(22) PCT Filed: Nov. 5, 2018
(86) PCT No.: PCT/SG2018/050559

§ 371 Date: Oct. 5, 2020

(30) Foreign Application Priority Data
Apr. 3, 2018 (SG) 10201802790V

(51) Int. Cl. G09B 19/00; G06Q 50/20; G06Q 10/06; G06Q 30/02; G09B 7/00

(52) U.S. Cl. CPC G09B 19/00; G06Q 50/2057; G06Q 10/06398; G06Q 10/087; G06Q 30/0267; G09B 7/00; G06Q 30/0258

(57) ABSTRACT

An interactive platform which includes an educational and training content video library, to allow alcohol companies to conveniently reach, train and influence the on-premise service staff who sell their products across different service industries is provided. Hospitality outlets and alcohol companies can upload training videos onto the platform for service staff to view at their own convenience. Quizzes administered after the training videos are played further enables the hospitality outlets and alcohol companies to monitor and enhance knowledge retention. The embodiments also allow alcohol companies to effectively update on-premise service staff on recipes and promotional activities relating to their products. The embodiments therefore help to boost the sales of alcohol products by improving the quality of training for on-premise service staff as well as communicating information and new recipes in a simple, fast and efficient manner.

### CROSS-REFERENCE TO RELATED APPLICATIONS

This application claims priority to PCT Application No. PCT/SG2018/050559 having a filing date of Nov. 5, 2018, which is based on SG Application No. 10201802790V, having a filing date of Apr. 3, 2018, the entire contents both of which are hereby incorporated by reference.

### FIELD OF TECHNOLOGY

Disclosed is a wholly computer-implemented guided training program and method that relates to a platform which facilitates the exchange of information between alcohol companies and their potential customers, hospitality outlets and on-premise service staff, retail outlets that sell alcohol and their staff, talent agencies and promoters who work short term to promote alcohol at events or within venues (hereinafter collectively referred to as “Application Users”, and each individual Application User may be referred to as a “Alcohol Company”, “Customer”, “Venue” and “Staff” respectively).

### BACKGROUND

The alcohol industry is a multibillion-dollar business worldwide with the majority of sales made in developed economies. In recent years, there has been an important shift towards emerging markets such as Southeast Asia, where the majority of growth stems from. In particular, a key area driving growth is on-premise sales, where service staff at hospitality outlets recommend and educate customers about the products they sell and in turn persuade these customers to purchase and consume these products.

Despite the immense potential for growth in emerging markets and the size of the industry as a whole, there have been a number of challenges regarding the marketing of alcohol brands in these emerging markets.

One problem is that on-premise service staff often do not know enough about the category of products to effectively sell them. This is especially important for more premium products which require greater product knowledge on the part of the service staff to sell them because their unique selling propositions are more complex.

Presently, the cost of training of on-premise service staff regarding the products they sell is often high. In emerging markets, alcohol companies often work with local distributor partners to sell their products. Alcohol companies often hire brand ambassadors who are then assigned to a geographical region and tasked with advocating and promoting the brand to the service staff Because of this arrangement, it is expensive for brand ambassadors to travel within the large assigned geographical area to deliver training sessions in person. This is exacerbated by the nature of shift work that service staff engage in. As a result, multiple training sessions have to be scheduled in order to deliver the training programme to all staff members.

Not only is such training expensive, it is also often ineffective as well. Due to language barriers, cultural differences and differing levels of understanding about the brand, training the service staff who attend these training sessions is still difficult and potentially prone to miscommunication and/or misinformation. Furthermore, the lack of post-training evaluations hinders the ability of alcohol companies and hospitality outlets to assess the effectiveness of these training sessions.

While alcohol brands have already set up websites and internal training platforms to train service staff, these methods are often ineffective as well because service staff do not find such platforms to be easily accessible and/or the instructions therein to be clear. As such, viewership and engagement of on-premise staff on these platforms are often low.

Further, the costs to create content and set up such platforms are very high, meaning only a limited number of the largest conglomerates, which may have several market leading brands, are able to afford the set up costs. Even though these companies are large, the market share of their alcoholic beverages (i.e. the specific brands of their alcohol) amongst all the brands of alcoholic beverages offered by the hospitality venue may be small, meaning that for many venues the value of the training does not outweigh the internal administration required by these conglomerates to set up their staff on the platform and monitor their progress through the training.

The embodiments therefore seeks to address the above issues which currently plague the training of on-premise service staff and the marketing of alcohol brands in emerging markets today.

### SUMMARY

An aspect relates to a platform which facilitates the exchange of information between alcohol companies and their potential customers, hospitality outlets and on-premise service staff, retail outlets that sell alcohol and their staff, talent agencies and promoters who work short term to promote alcohol at events or within venues (hereinafter collectively referred to as “Application Users”, and each individual Application User may be referred to as a “Alcohol Company”, “Customer”, “Venue” and “Staff” respectively). This will thus enable service Staff to be better trained to be more knowledgeable about the alcohol products they sell and help improve alcohol sales in emerging markets as a result.

According to one embodiment, the invention will host a training content video library, with videos which include subtitles in multiple languages. It envisions a two-sided business model in which access to this platform will be free for all Venues, which may upload their own content and branding on the platform. This enables Venues to train their Staff effectively, at minimal cost. Alcohol Companies will pay to use the platform to deliver brand training to reinforce their brand recognition among on-premise service Staff and their potential Customers. Embodiments of the invention will become part of Staff learning plans and/or training schemes such that all on-premise service Staff will be able to watch the videos and become more knowledgeable about the alcohol products that they are to sell.

In another embodiment, this invention will administer quizzes to service Staff to complete after they finish watching the videos. This will help Venues track the knowledge retention of the Staff, and also is a viable means for the Alcohol Companies and/or Venues to track the performance of the Staff and also the effectiveness of such learning plans and/or training schemes.

According to another embodiment, the invention further enables Venues to compare current stock taking information or point of sale with training records in order to measure the impact of training and promotions on sales. It does so by collecting stock movement data on the products sold by the Venues.

In the ideal embodiment of this invention, Alcohol Companies can use information from the results of the tests and quizzes taken by the Staff to modify the content in their lessons to improve comprehension and use such insights to focus spending on lessons and campaigns that have a positive impact on sales. Alcohol Companies can drive sales by communicating upcoming promotions to outlets, introducing new products and delivering lessons on what makes their products special and how to sell it to Customers. Alcohol Companies can also upload recipes that include their products into the virtual menu to simplify the process of adding their products into real world menus and training hospitality Staff how to create the recipe constantly. This helps Alcohol Companies market their products better in emerging markets.

In another embodiment of the invention, it will also contain a repository of all relevant information pertaining to a particular brand of alcohol's history, company profile and information, manufacturing processes, ingredients and types of alcoholic beverages, amongst others. This information would also be made readily accessible to on-premise service Staff and the Alcohol Companies' potential Customers, and would again increase brand recognition and awareness.

In another embodiment of this invention, Alcohol Companies will be able to search the properties of User Interface Codes and deliver brand training lessons and alcohol beverage recipe and mixology lessons to specific Venues. This targeting will allow all Venues to receive relevant content and for brands to customize content for the specific needs of the targeted Customers.

### BRIEF DESCRIPTION OF THE DRAWINGS

Some of the embodiments will be described in detail, with references to the following Figures, wherein like designations denote like members, wherein:

FIG. 1 is an overview of embodiments of the invention which facilitates the exchange of information between the Application Users (i.e. the specific Alcohol Companies and their potential Customers, hospitality outlets and on-premise service Staff), and all through either a desktop and/or mobile application (the “Application”), and which shall be made available online on the World Wide Web via a telecommunications network. Further, the diagram also shows the content, the different interfaces of embodiments of the invention, and which the content shall be created for and on which the Application Users can access such content;

FIG. 2 is a focused view on how a new product can be created by an Application User on the Application, and further how an Application User can also create a particular brand campaign; and

FIG. 3 is a focused view on how an Application User's brand's uploaded content and lessons reach its target demographic, during the course of a particular brand campaign.

### DETAILED DESCRIPTION

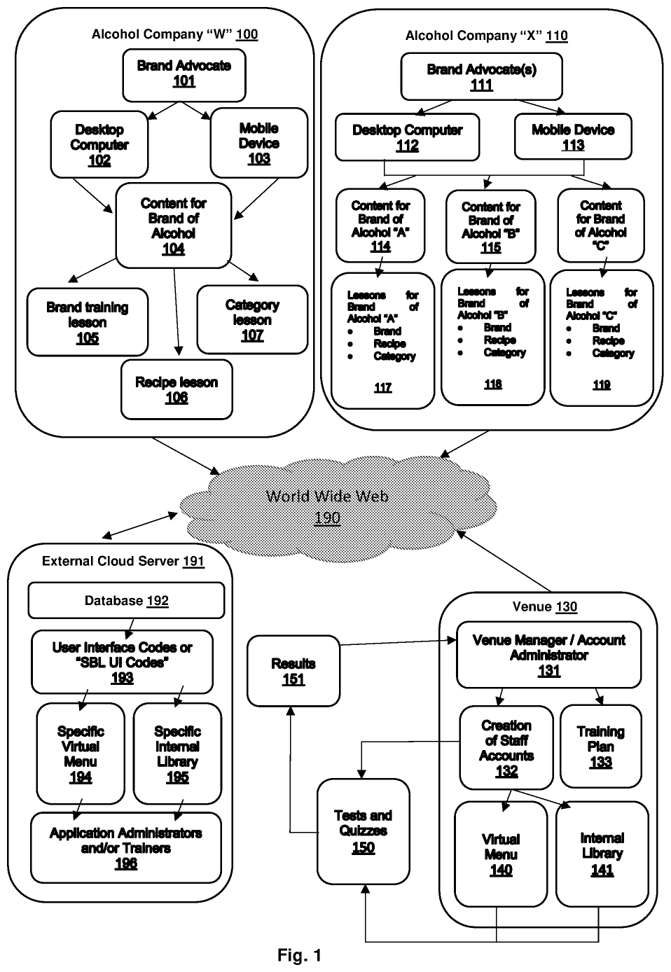

According to FIG. 1, embodiments of the invention will be made available for Application Users to access from the World Wide Web via a telecommunications network 190. As there are several identified types of Application Users (i.e. an Alcohol Company, Customer, Venue and Staff), the creation of content and the accessing of content via the Application shall be dependent on the type of Application User account registered and/or assigned to the specific Application User.

For example, and in relation to Alcohol Company “W” 100, the brand advocate 101 of that Alcohol Company would first create an account for the Application either through a desktop computer 102 or a mobile device 103. The brand advocate, through his Application User account would then be able to create content in relation to the specific brand of alcohol he would be tasked with promoting 104. The content for the specific brand of alcohol for Alcohol Company “W” would then include brand training lessons 105, and which may include more information about the brand of alcohol to be promoted, including information pertaining to the type of alcohol, the ingredients information, manufacturing process, vintage, taste and flavor profiles and the alcohol's proof, amongst other relevant and useful information about that brand of alcohol. The content 104, may also contain other lessons such as recipe lessons 106, which would contain cocktail recipes and instructional guides and information for other Application Users to access and learn from. Furthermore, the content 104, would also include other category lessons, which shall include other general information such as the history, origin and founding of Alcohol Company “W” itself, and other relevant and informative content as well. The content 104 and the various lessons thereunder 105, 106 AND 107 may be in the form of written articles (in various languages), audio files (or “Podcasts”) and videos, all of which may be created and uploaded by the brand advocate to the Application on the World Wide Web via a telecommunications network 190.

Further to the above and as a further example, in relation to Alcohol Company “X” 110, the brand advocate(s) 111 would also be able to register for an Application User account via the various platforms of either a desktop computer 112 or a mobile device 113, and after having done so, they may then create content for the various brands of alcohol for which the brand advocate(s) are charged with promoting. For example, different content can be created for the various brands of alcohol by the brand advocate(s), and which shall be specific to the type (e.g. vodka, whisky, rum and/or gin, amongst others) and brand of the alcohol 114, 115 AND 116, and this would be a method of content creation on the Application in the case of a multi-brand Alcohol Company. In relation to the brand of alcohol identified in FIG. 1 (i.e. Brand of Alcohol “A”, “B” and “C”) 114, 115 AND 116, the brand advocate(s) would then be able to create different lessons accordingly and in relation to each brand of alcohol 117, 118 AND 119, and such respective lessons shall include the same group of lessons (i.e. brand training, recipe and category) as Alcohol Company “W” 105, 106 AND 107, and shall also be comprised of written articles, podcasts and/or videos.

For Application User which are Venues, they would also be able to access the Application on the World Wide Web via a telecommunications network 190, and the content that may have been uploaded to the Application by other Application Users, and which may include, amongst others, the content and lessons created by the brand advocate(s) of the various Alcohol Companies 104, 105, 106, 107, 114, 115, 116, 117, 118 AND 119. The Application User account for the Venue may be created by the account administrator whom shall usually be the manager of the Venue or hospitality or food and beverage outlet(s) (the “Venue Manager”). Similar to the brand advocate(s) 101 AND 111 of the various Alcohol Companies, the Venue Manager may also choose to register his Application User account for the Application via a desktop computer 102 AND 112 or mobile device 103 AND 113. Once the Venue Manager has done so, he may then commence creating other Application User account for the Staff which are employed at the respective Venue (i.e. onboarding of Staff accounts for the Application) 132.

Once the Venue Manager has created an Application User account, he would also then have access to multiple customizable training plans 133 which suit the different job types and Staff deadlines within the outlet. Each training plan 133 shall include informative, interactive and educational content and lessons of the various Alcohol Companies 104, 105, 106, 107, 114, 115, 116, 117, 118 AND 119, and may also contain the content and lessons that may have been created by the Venue Manager, Administration Manager or Trainers of the Application and which may be readily available to the Staff via the Application's internal library 141 and training materials, and the training plan 133 shall also include tests and quizzes 150 that may be created for the specific lessons by the Alcohol Company's brand advocate(s) and/or the Administrators and Trainers of the Application, and/or the Venue Manager/Account Manager to be undertaken by the Staff. Once the Staff have been on-boarded and have a registered account with the Application, the Staff would then be able to access the virtual menu 140 and the internal library 141, and all the training lessons and content collated and particularised thereunder. By accessing such lessons and content, the Staff can then undertake the necessary training and view such educational and informative content, in relation to the specific type and/or brand of alcohol which they are to sell and/or otherwise promote for sale at the Venue. The Venue Manager's Application User account would also allow the him to customise the training plan 133, virtual menu 1402 and the internal library 141 to select content and training materials that would be relevant and suitable for that particular Venue, the interface of the training plan 133, virtual menu 1402 and the internal library 141 would therefore be specific and bespoke to each Venue and depending on the customisations and/or the relevant selections made by the Venue Manager.

After the relevant Staff accesses and completes a particular lesson, by selecting the lesson via the virtual menu 140 or training plan 133 or internal library 141, the Staff would then receive a notification via the Application 150 to undertake a test and/or quiz on the same subject matter which was covered in the course of that particular lesson. Libraries 195, 141 can be accessed at any time by the Staff and Staff can complete lessons (and associated quizzes) on their own volition. Once the Staff has completed the relevant test and/or quiz 150, the results would then be sent to the Venue Manager, application manager and specific brands (if applicable) 151, and he would then be able to track and monitor the performance and competency of the Staff at the Venue. If the Staff does not pass the test and/or quiz, then the Staff would be required to do the same lesson again 140 AND 141 and then re-take the test and/or quiz 150 until the Staff achieves the requisite passing result 151, and to the Venue Manager's satisfaction that the Staff is proficient and sufficiently knowledgeable about the types and/or brands of alcohol to be sold and/or offered for sale at the Venue. Similar to the brand advocate(s) of the respective and various alcohol companies 101 AND 111, the Venue Manager would also be able to create specific content which may be specific to the Venue 130 that he has charge over, and this content may also be uploaded via the Venue Manager's Application User Account 131, and such content may also be selected to be included in the training plan 133, virtual menu 140 and the internal library 141. Such Venue specific training content and/or lessons may include information related to that particular Venue's service standards and other employee guidelines such as working hours, attire and dress code and code of conduct, amongst other relevant information.

Further to the above FIG. 1 also shows where and how all the content, whether created by brand advocate(s) 101 AND 111 or Venue Managers 130, shall be stored and/or otherwise accessed from via the World Wide Web via a telecommunications network 190. When content is created and uploaded to the Application, the information will first be transmitted via an external cloud server 191, and which would then comprised of a backend database 192, where such content shall be processed and/or otherwise stored. Similarly, when an Application User desires to access the content stored on the Application's backend database 192, the content would be retrieved and broadcast via the external cloud server 191 to the World Wide Web 190, and therefore accessible to the Application User via his desktop computer and/or mobile device.

The database 192 shall also store and transmit to all Application Users their User Interface Codes (or hereinafter also referred to as the “SBL UI Codes”) 193, and which shall be a unique alpha-numeric code that shall be assigned to the Application User at the time of registration of their Application User account, and which will be used to identify each individual Application User's account and their corresponding personal information, interface customisation preferences, completed lessons and test results, amongst other information. The SBL UI Codes 193 will also determine and track which specific virtual menu 194 and/or internal library 195 the specific Application User would be allowed to access via the Application at all the relevant and material times. For example, after the Venue Manager 131 has customised the training plan 133, virtual menu 140 and internal library 141 for that particular Venue, and had also previously created the relevant Staff Application User accounts 132, then the Staff's SBL UI code would be locked to that particular Venue 130, and that Staff shall therefore only be allowed to access the training plan 133, virtual menu 140 and internal library 141 for that particular Venue.

By storing and processing the content and information of the Application on a backend database 192, the Application can also be accessed by the Application Administrators and/or Trainers (i.e. Super Admin or Master Admin accounts) 196. When Application Users experience any difficulties and/or report errors or bugs in the Application and specifically in the specific virtual menu 194 or the specific internal library, then the Application Administrators and/or Trainers would be able to access the Application via the database 192 to amend any such errors or bugs, or otherwise assist the relevant brand advocate(s) 101 AND 111 and Venue Manager 131 to customise any of their training content and/or lessons as previously uploaded to the Application.

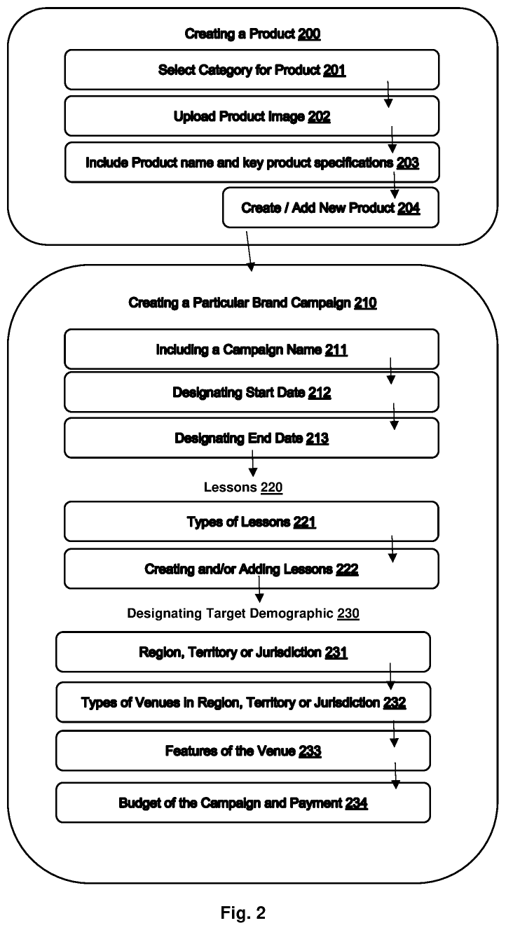

FIG. 2 shows how an Application User with an account (and which shall usually be 196 or an Alcohol Company and/or their respective brand advocate(s)) may create a new product may be created on the Application 200. This is done by first selecting the category for the product 201, and this would depend upon the nature of the alcohol (e.g. beer, hard liquor, spirit or aperitif, etc.) and the type of alcohol (e.g. vodka, whisky, gin, etc.). Next, the Application User shall upload an image of the product to be created on the Application 202, and thereafter include the name and key product specifications of the product 203. Once the Application User is satisfied that information and details of the product is accurate and acceptable, the Application User may then proceed to create or add the new product to the Application 204.

After the product has been created 204, and depending on the Application User's preference, the Application User and in this case usually a brand advocate, may then decide to promote that particular product and/or brand of alcohol by embarking on a brand campaign through the Application. The Application User would then proceed to create a particular brand campaign through the Application 210.

The Application User would start the creation of the brand campaign by first inputting some basic information about the campaign by selecting the product that he had previously created 200, and then including the name of the campaign 211 and also designating the start date and end date (where applicable) of the campaign, and therefore the total duration for which the campaign is to last for 212 AND 213. This would be useful for the Application User as they would be able to designate the start and end date of the campaign to coincide with brand re-positioning periods or certain festive periods and/or sporting events, which typically see more alcohol sales during that time.

Once the Application User has input the basic information about the campaign, he would then be required to identify the lessons to be included within the brand campaign 220, and which would include the types of lessons 221, and which would comprise of brand training, recipe and category lessons (please refer to FIG. 1 at 105, 106, 107, 117, 118 AND 119) or any lessons that have been uploaded, and the text articles, podcasts and/or videos created therefor. If the Application User had not previously created such lessons and/or content, then he may also create and/or add new lessons via the Application for this specific brand campaign 222, and this may be the case if new recipes for cocktails are to be added to coincide with a specific festive period and/or sporting event, or this particular brand campaign or promotion.

The final step for the Application User to launch his brand campaign would then be to designate the target demographic 230 of this particular brand campaign. The Application User would then be required to identify which region, territory or jurisdiction (i.e. country) he may wish to launch his brand campaign in 231, and therefore where he wishes to promote his particular brand of alcohol for sale. The Application User would have the further ability to undertake pinpoint advertising and promotion efforts to increase the effectiveness of his campaign by identifying the specific types of Venues he may wish to target in the region, territory or jurisdiction of his choice 232. The sales process and consumption differ based on the type of Venue and clientele. Guests of a luxury hotel have different expectations to a guest of a casual pub. Hence, targeted marketing is used as the sales strategy. Through targeted marketing, brand advocates of alcohol beverages are able to tailor lessons to cater to these differences and then use the targeting function to deliver it to suitable Venues. The feature also allows brands to create lessons that caters to specific cultures and languages.

Further to the above, the Application User would then be able to include features of the Venue 233. The Application User would thereafter be prompted and notified through the Application on the total budget for his brand campaign (based on the information and parameters input into the Application by the Application User) and the Application User would then be required to accept and make payment before the brand campaign is to be launched via the Application, upon the Application Administrator's approval of the campaign

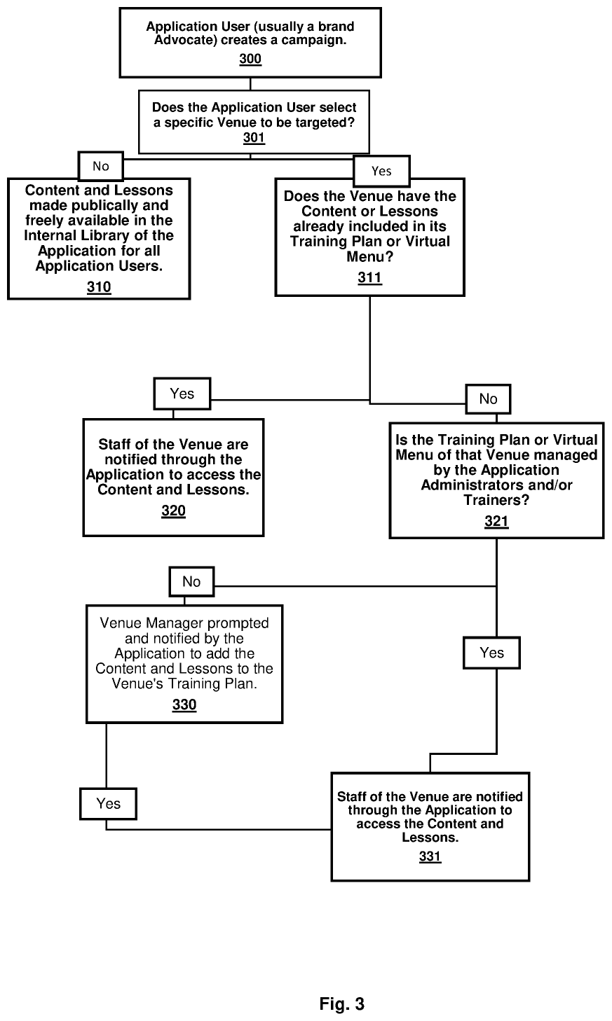

FIG. 3 shows how an Application User's uploaded content and lessons reach its target demographic, during the course of a particular brand campaign, and therefore how the target demographic (which comprise of other Application Users such as Customers, Venue and/or Staff) interact, view and engage with the same during the course of the campaign, or otherwise.

After the Application User creates a particular brand campaign 300, he would be required to designate a particular region, territory and jurisdiction (please refer to FIG. 2 at 231), and would also therefore then be required to identify the types of Venues in that region, territory or jurisdiction he then wishes to further target (please refer to FIG. 2 at 232). Thereafter, based on such parameters, the Application User would then be provided with a further list of Venues for him to choose from, and if the Application User has selected a particular Venue 301, the Application User would then need to select a specific Venue within the list provided by the Application 301.

If the Application User does not then decide on a specific Venue to be targeted, then the content for that particular brand of alcohol may be made publicly available to all Application Users, with either paid and/or unpaid Application User accounts, through the Application 310. The brand can select if their content is open for use or available for only a specific target. While the content may be publicly available, Application Users will not however be notified and/or otherwise prompted by the Application to access such content, and the Application therefore functions as a repository and directory of such content, which may include text articles, podcasts and videos about that particular brand and/or type of alcohol.

If the Application User does select a particular Venue, then the Application will determine if the Venue already has that particular Application User's Product included in the Venue's virtual menu 140. If the Venue does already have the content and lessons included within its existing training plans, then the Staff of the Venue will be notified via the Application to access such content and lessons 320, if they have not already done so, and will also be notified of the launch of any particular brand campaign.

If the content and lessons are not already included within that particular Venue's existing training plan, then the Application will next determine if the training plan of that Venue is currently being managed by the Application Administrators and/or Trainers of the Application 321. If the training plan of the Venue is not presently managed by the Application Administrators and/or Trainers then the Venue Manager will be prompted and notified by the Application to add the content and lessons to the Venue's training plan 330, and thereafter the Staff of the Venue shall be notified via the Application to access the content and lessons accordingly 331. In the event that the training plan of the Venue is managed by the Application Administrators and/or Trainers, then the Staff of the Venue shall be notified through the application to access the content and lessons 331.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A wholly computer-implemented guided training program, comprising:
a. a user-interface for the development, management and the uploading of marketing, promotional, training and educational content in relation to various types of alcohol, alcoholic beverages or alcohol products;
b. an online interactive training platform which includes quizzes, tests and records of results of such quizzes and tests, and which are then used to measure the impact of such training;
c. such user interface also allowing the alcohol companies to conduct training and educate on-premise service staff, who are responsible for the sale of alcohol, on the implementation of targeted marketing and promotional activities; and
d. an external cloud server for the transmission and storage of marketing, promotional, training and educational content, and wherein such content may be accessed, managed and edited simultaneously,
thus allowing the venues, in particular, hospitality outlets and alcohol companies, to receive information and materials that are relevant to their needs and the needs of their customers, and alcohol companies to conveniently reach and train on-premise service staff in order to improve the sales of their alcohol products across these different venues.

2. (canceled)

3. The computer-implemented guided training program according to claim 1, further comprising a dynamic user interactive virtual menu, wherein the users of the platform can access the platform's internal library of training and educational content.

4. The computer-implemented guided training program according to claim 3, wherein the user interactive virtual menu and the content shall further comprise user selectable links categorised into different groups consisting of:
a. the type of alcohol selected from wines, beers spirits, mixed drinks including cocktails and non-alcoholic drinks;
b. the sub-type of alcohol selected from spirits including Vodka, Rum, Gin, Whiskey;
c. The brand and products of that brand of alcohol; and
all of the above further being customised according to each specific venue.

5. The computer-implemented guided training program according to claim 4, further comprising a user interface which allows venue managers to track and monitor the performance of its staff, upload and manage the training and educational content to better suit the particular venue and its staff, such that training, education and alcohol-related knowledge can be improved and maximized.

6. The computer-implemented guided training program according to claim 5, further comprising a function for alcohol companies to undertake pinpoint and targeted marketing and advertising directed at the relevant venues.

7. The computer-implemented guided training program according to claim 6, wherein each user account comprises an individualized user interface code which shall be a unique alpha-numeric code which is assigned at the time of registration of the account and which shall be used to identify the users and their corresponding personal information and preferences.

8. The computer-implemented guided training program according to claim 7, wherein access to at least one of the virtual menu and internal library is customised such that each user is only allowed to view the targeted marketing and promotional, training and educational content available to the particular venue which the user is registered under.

9. The computer-implemented guided training program according to claim 8, further comprising a downloadable mobile application for installation on a user's mobile or tablet device, or operated through a computer on an online web-browser, and with both device and computer being connected to the world wide web via a communications network.

10. A method for providing training and instruction, comprising:
a. a user-interface for the development, management and the uploading of marketing, promotional, training and educational content in relation to various types of alcohol, alcoholic beverages or alcohol products;
b. an online interactive training platform which includes quizzes, tests and records of results of such quizzes and tests, and which are then used to measure the impact of such training;
c. such user interface also allowing the alcohol companies to conduct training and educate on-premise service staff, who are responsible for the sale of alcohol, on the implementation of targeted marketing and promotional activities; and
d. an external cloud server for the transmission and storage of marketing, promotional, training and educational content, and wherein such content may be accessed, managed and edited simultaneously.

11. (canceled)

12. The method according to claim 10, further comprising a dynamic user interactive virtual menu, wherein the users of the platform can access the platform's internal library of training and educational content.

13. The method according to claim 12, wherein the user interactive virtual menu and the content further comprise user selectable links categorised into different groups consisting of:
a. the type of alcohol including wines, beers or spirits, mixed drinks including cocktails and non-alcoholic drinks;
b. The sub-type of alcohol or spirits including Vodka, Rum, Gin, Whiskey;
c. The brand and products of that brand of alcohol; and
all of the above further being customised according to each specific venue.

14. The method according to claim 13, further comprising a user interface which allows venue managers to track and monitor the performance of its staff, upload and manage the training and educational content to better suit the particular venue and its staff, such that training, education and alcohol-related knowledge can be improved and maximized.

15. The method according to claim 14, further comprising a function for alcohol companies to undertake pinpoint and targeted marketing and advertising directed at the relevant venues.

16. The method according to claim 15, wherein each user account comprises an individualized user interface code which shall be a unique alpha-numeric code which is assigned at the time of registration of the account and which shall be used to identify the users and their corresponding personal information and preferences.

17. The method according to claim 16, further comprising the step of customising a user's access to at least one of the virtual menu and internal library such that each user is only allowed to view the targeted marketing, promotional, training and educational content available to the particular venue which the user is registered under.

18. The method according to claim 17, further comprising a downloadable mobile application for installation on a user's mobile or tablet device, or accessed using a computer on an online web-browser, and with both device and computer being connected to the world wide web via a communications network.
